(19) United States
(12) Patent Application Publication
(10) Pub. No.: US 2020/0163118 A1
(43) Pub. Date: May 21, 2020

(54) COLLISION DETECTION

(71) Applicant: QUALCOMM Incorporated, San Diego, CA (US)

(72) Inventors: Xiaolong Huang, San Jose, CA (US); Lei Li, Milpitas, CA (US); Srinivas Katar, Fremont, CA (US)

(21) Appl. No.: 16/194,026

(22) Filed: Nov. 16, 2018

(51) Int. Cl. H04W 74/08; H04L 1/00; H04L 5/00; H04W 80/02; H04B 17/318; H04B 17/336; H04W 72/12

(52) U.S. Cl. CPC H04W 74/0825; H04L 1/0003; H04L 5/0055; H04W 80/02; H04W 84/12; H04B 17/336; H04W 74/0858; H04W 72/121; H04B 17/318

(57) ABSTRACT

This disclosure provides methods, devices and systems for selecting a first group of wireless communication devices to receive a first multi-user (MU) protocol data unit (PDU). A threshold value for identifying collisions of PDUs is determined based on the number of devices in the first group of devices. A second group of wireless communication devices is selected to receive a second MU PDU. Responsive to determining that an acknowledgment (ACK) acknowledging the second MU PDU has not been received from a device of the second group of devices within a threshold duration of time, a number of ACKs, including the ACK, that have not been received from the respective device is determined. An action is then performed based on the determined number of ACKs and the threshold value. In some implementations, the action includes reducing a data rate or initiating a backoff operation.

### TECHNICAL FIELD

This disclosure relates generally to wireless communications, and more specifically, to detecting collisions of wireless communications.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Access to the shared wireless medium may be based on contention. Before a wireless communication device, such as an AP or a STA, is permitted to transmit data, it must wait for a particular time and then contend for access to the wireless medium. For example, before transmitting data, the wireless communication device must perform a channel assessment and determine that the appropriate wireless channel is idle. If the channel is idle, the wireless communication device may initiate a backoff timer, which represents a duration of time that the device must sense the medium to be idle before it is permitted to transmit. If the channel remains idle until the backoff timer expires, the wireless communication device may begin transmitting.

If, when the backoff timer expires, the wireless communication device transmits the communication but the medium is still busy, there may be a collision of the communication with another wireless transmission from another device. Additionally, if there is otherwise too much energy on the wireless channel resulting in a poor signal-to-noise ratio (SNR), the communication may be corrupted or otherwise not successfully received. A wireless communication device that successfully receives a wireless communication from another device may be configured to comply with an acknowledgement policy that may be indicated by the communication. For example, the acknowledgement policy may indicate to the wireless communication device that it must transmit a communication acknowledging the successful reception of the communication after a short time period. In instances of a collision or poor SNR, the wireless communication device that transmitted the communication may not receive an acknowledgement from the intended recipient of the communication.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication performed by a first wireless communication device. Another innovative aspect of the subject matter described in this disclosure can be implemented in a wireless communication device configured to perform operations for wireless communication. In some implementations, the method and operations include selecting a first plurality of wireless communication devices to concurrently receive a first multi-user (MU) protocol data unit (PDU) that includes a respective first PDU for each of the first plurality of wireless communication devices. The method and operations also include generating and transmitting, or outputting for transmission, the first MU PDU. The method and operations also include determining a threshold value for identifying collisions of PDUs based on a number of wireless communication devices in the first plurality of wireless communication devices. The method and operations also include selecting a second plurality of wireless communication devices to concurrently receive a second MU PDU that includes a respective second PDU for each of the second plurality of wireless communication devices. The method and operations also include generating and transmitting, or outputting for transmission, the second MU PDU. The method and operations also include determining that an acknowledgment (ACK) acknowledging the respective second PDU has not been received from a second wireless communication device of the second plurality of wireless communication devices within a threshold duration of time. The method and operations additionally include determining a number of ACKs, including the ACK, that have not been received from the second wireless communication device. The method and operations further include performing an action based on the determined number of ACKs and the threshold value.

In some implementations of the method and operations, the transmission of the first MU PDU occurs during a first transmit opportunity (TXOP), the transmission of the second MU PDU occurs during a second TXOP subsequent to the first TXOP, and the method and operations further include updating the threshold value on a per-TXOP basis based on the number of wireless communication devices selected to concurrently receive an MU PDU during the respective TXOP.

In some implementations, the method and operations may further include selecting at least a subset of the first plurality of wireless communication devices to concurrently transmit a third MU PDU to the first wireless communication device, and transmitting a fourth PDU after transmitting the second MU PDU to trigger the transmission of the third MU PDU from the subset of the first plurality of wireless communication devices. In some implementations, the determination of the threshold value for identifying collisions of PDUs based on the number of wireless communication devices in the first plurality of wireless communication devices comprises determining the threshold value based on the number of wireless communication devices in the first plurality of wireless communication devices and the number of wireless communication devices in the subset of the first plurality of wireless communication devices. In some implementations, the determination of the threshold value comprises querying a lookup table to obtain the threshold value based on the number of wireless communication devices in the first plurality of wireless communication devices and the number of wireless communication devices in the subset of the first plurality of wireless communication devices. In some implementations, the determination of the threshold value comprises determining the threshold value based on a ratio of the number of wireless communication devices in the first plurality of wireless communication devices to the number of wireless communication devices in the subset of the first plurality of wireless communication devices.

In some implementations, the method and operations may further include determining an expected number of wireless communication devices that may contend for access to transmit respective single-user (SU) PDUs to the first wireless communication device based on the number of wireless communication devices in the first plurality of wireless communication devices, wherein the determination of the threshold value for identifying collisions of PDUs based on the number of wireless communication devices in the first plurality of wireless communication devices comprises determining the threshold value based on the expected number. In some implementations, the determination of the expected number further includes determining a number of wireless communication devices outside of the first plurality of wireless communication devices that may contend for access to transmit respective SU PDUs to the first wireless communication device. In some such implementations, the determination of the number of wireless communication devices outside of the first plurality of wireless communication devices includes determining a number of MU-capable wireless communication devices that have buffered traffic for the first wireless communication device. In some such implementations, the determination of the number of MU-capable wireless devices that have buffered traffic for the first wireless communication device includes receiving a buffer status report from each of a plurality of MU-capable wireless devices and identifying the number of MU-capable wireless devices that have buffered traffic for the first wireless communication device based on the received buffer status reports.

In some implementations, the determination of the number of wireless communication devices outside of the first plurality of wireless communication devices comprises determining a number of non-MU-capable wireless communication devices that may contend for access to transmit respective SU PDUs to the first wireless communication device. In some such implementations, the determination of the number of non-MU-capable wireless communication devices that may contend for access includes identifying non-MU-capable wireless communication devices that have transmitted SU PDUs to the first wireless communication device within a threshold duration of time and determining the number of non-MU-capable wireless communication devices that may contend for access based on the identified non-MU-capable wireless communication devices.

In some implementations, the method and operations may further include determining an expected ACK failure rate based on the expected number, determining an actual ACK failure rate, and increasing the threshold value responsive to determining that the actual ACK failure rate is greater than the expected ACK failure rate or maintaining or reducing the threshold value responsive to determining that the actual ACK failure rate is less than the expected ACK failure rate.

In some implementations of the method and operations, the determination of the threshold value further includes determining a received signal strength indicator (RSSI) value associated with each of one or more neighboring APs, comparing the RSSI values with a threshold RSSI, and determining the number of neighboring APs having associated RSSI values greater than the RSSI threshold, wherein the determination of the threshold value is further based on the determined number of neighboring APs having associated RSSI values greater than the RSSI threshold.

In some implementations of the method and operations, the determination of the number of ACKs that have not been received includes determining the number of consecutive ACKs, including the ACK, that have not been received from the second wireless communication device. In some such implementations, the performance of the action is based on the determined number of consecutive ACKs.

In some implementations of the method and operations, the performance of the action based on the determined number of ACKs and the threshold value includes initiating a backoff operation responsive to determining that the number of ACKs is less than the threshold value. In some implementations of the method and operations, the performance of the action based on the determined number of ACKs and the threshold value includes reducing a modulation and coding scheme (MCS) associated with transmissions of PDUs to the second wireless communication device responsive to determining that the number of ACKs is greater than the threshold value. In some such implementations, the method and operations may further include determining a first ACK failure rate prior to reducing the MCS, determining a second ACK failure rate after reducing the MCS, and increasing the threshold value responsive to determining that the second ACK failure rate is greater than or equal to the first ACK failure rate, or maintaining or reducing the threshold value responsive to determining that the second ACK failure rate is less than the first ACK failure rate.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example PHY protocol data unit (PPDU) usable for communications between an AP and a number of STAs.

FIG. 3 shows a block diagram of an example access point (AP) for use in wireless communication.

FIG. 4 shows a block diagram of an example (STA) for use in wireless communication.

FIG. 5 shows a timing diagram illustrating an example sequence of wireless communications.

FIG. 6 shows a flowchart illustrating an example process for detecting collisions according to some implementations.

FIG. 7 shows a flowchart illustrating an example process for performing one or more actions based on a determined number of acknowledgement failures and a threshold value according to some implementations.

FIG. 8 shows a flowchart illustrating an example process for determining a threshold value for identifying collisions according to some implementations.

FIG. 9 shows a flowchart illustrating an example process for determining a threshold value for identifying collisions according to some implementations.

FIG. 10 shows a flowchart illustrating an example process for updating a threshold value according to some implementations.

FIG. 11 shows a flowchart illustrating another example process for updating a threshold value according to some implementations.

FIG. 12 shows a flowchart illustrating an example process for determining a threshold value based on other BSS (OBSS) characteristics according to some implementations.

FIG. 13 shows a block diagram of an example wireless communication device for use in wireless communication according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to techniques for collision detection. Particular implementations more specifically relate to techniques for dynamically changing a threshold value used for distinguishing a collision from other network conditions such as poor signal-to-noise ratio (SNR). For example, a wireless communication device, in response to not receiving an acknowledgement (ACK), may compare the number of consecutive ACK failures to the threshold value. If the number of consecutive ACK failures is greater than the threshold value, the wireless communication device may determine that the current ACK failure is the result of poor SNR or other adverse network characteristics. Conversely, if the number of consecutive ACK failures is less than the threshold value, the wireless communication device may determine that the current ACK failure is the result of a collision. The wireless communication device may perform different actions depending on whether the current ACK failure is the result of a collision or poor SNR. For example, the wireless communication device may initiate a backoff operation in response to determining that the current ACK failure is the result of a collision, and may initiate a reduction in MCS in response to determining that the current ACK failure is the result of poor SNR.

In some implementations, a wireless communication device within an access point (AP) calculates, selects or otherwise determines the threshold value based on an expected number of stations (STAs) that will contend for access to transmit respective single-user (SU) communications. Additionally or alternatively, the wireless communication device may determine the threshold value based on a number of targeted recipients of a first multi-user (MU) transmission and a number of selected transmitters scheduled for a second MU transmission. For example, the AP may identify a first group of STAs to participate in a first downlink (DL) MU transmission to concurrently receive data from the AP. The AP may identify a second group of STAs to participate in a second uplink (UL) MU transmission to concurrently transmit data to the AP. In some such implementations, the AP may determine the threshold value based at least in part on a ratio of the number of STAs in the first group to the number of STAs in the second group. For example, the AP may increase the threshold value proportionately to the ratio. In other words, as the number of UL scheduled users increases, the AP would reduce the threshold. Conversely, as the number of non-scheduled users increases, and thus the expected number of users that will contend for access to the wireless medium increases, the AP would increase the threshold.

Particular implementations of the subject matter described in this disclosure can be implemented to realize one or more of the following potential advantages. In some implementations, the described techniques can be used to dynamically determine a threshold value for use in distinguishing whether an ACK failure is the result of a collision or as the result of poor SNR or other interfering network conditions. By dynamically updating the threshold value, a wireless communication device such as an AP can more accurately interpret an ACK failure as the result of a collision or poor SNR. This, in turn, enables the wireless communication device to perform one or more actions to increase the likelihood of a successful transmission. It is advantageous to dynamically select a threshold as opposed to using a static threshold as a network environment changes. For example, in an active or dense network, if the static threshold value is too large, too many ACK failures would be interpreted as resulting from collisions, and as such, an AP may initiate backoff operations too often resulting in a decrease of the time utilization of the wireless medium and, as a consequence, a reduction in throughput. On the other hand, if the threshold value is too small, the AP may interpret too many ACK failures as resulting from poor SNR, and as such, unnecessarily reduce the MCS resulting in a reduction in throughput.

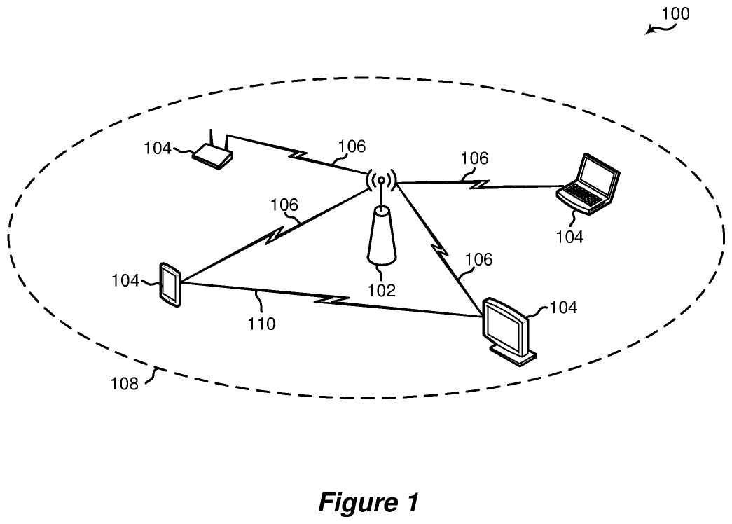

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. The BSS is identified by a service set identifier (SSID) that is advertised by the AP 102. The AP 102 periodically broadcasts beacon frames (“beacons”) to enable any STAs 104 within wireless range of the AP 102 to establish or maintain a respective communication link 106 (hereinafter also referred to as a “Wi-Fi link”) with the AP 102. For example, the beacons can include an identification of a primary channel used by the respective AP 102 as well as a timing synchronization function for establishing or maintaining timing synchronization with the AP 102. The various STAs 104 in the WLAN are able to communicate with external networks as well as with one another via the AP 102 and respective communication links 106. To establish a Wi-Fi link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link 106 with the selected AP 102.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

Some APs and STAs support beamforming. Beamforming refers to the focusing of the energy of a transmission in the direction of a target receiver. Beamforming may be used both in a single user context, for example, to improve a signal-to-noise ratio (SNR), as well as in a multi-user (MU) context, for example, to enable MU multiple-input multiple-output (MIMO) transmissions. To perform beamforming, a transmitter, referred to as the beamformer, transmits a signal from multiple antenna elements of an antenna array. The beamformer configures the phase shifts between the signals transmitted from the different antenna elements such that the signals add constructively along particular directions towards the intended receivers, which are referred to as beamformees. The manner in which the beamformer configures the phase shifts depends on channel state information associated with the wireless channels over which the beamformer intends to communicate with the beamformees. To obtain the channel state information, the beamformer may perform a channel sounding procedure with the beamformees. For example, the beamformer may transmit one or more sounding packets to the beamformees. The beamformees may then perform measurements of the channel based on the sounding packets and subsequently provide feedback to the beamformer based on the measurements, for example, in the form of a feedback matrix. The beamformer may then then generate a steering matrix for each of the beamformees based on the feedback and use the steering matrix to configure the phase shifts for subsequent transmissions to the beamformees.

The APs 102 and STAs 104 may function and communicate (via the respective Wi-Fi links 106) according to the IEEE 802.11 family of standards (such as that defined by the IEEE 802.11-2016 specification or amendments thereof including, but not limited to, 802.11ah, 802.11ay, 802.11ax, 802.11az, 802.11ba and Extremely High Throughput (EHT)). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer (PHY) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Access to the shared wireless medium is governed by a Distributed Coordination Function (DCF). With a DCF, there is no centralized master device allocating time and frequency resources of the shared wireless medium. On the contrary, before a wireless communication device, such as an AP 102 or a STA 104, is permitted to transmit data, it must wait for a particular time and then contend for access to the wireless medium. In some implementations, the wireless communication device may be configured to implement the DCF through the use of Carrier Sense Multiple Access (CSMA) with Collision Avoidance (CA) (CSMA/CA) and timing intervals. Before transmitting data, the wireless communication device must perform a Clear Channel Assessment (CCA) and determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine whether the channel is busy. Physical carrier sensing also includes energy detection. Energy detection involves measuring the total energy the wireless communication device receives regardless of whether the received signal represents a valid frame. If the total energy detected is above a threshold, the medium is considered busy. Virtual carrier sensing is accomplished via the use of a Network Allocation Vector (NAV), an indicator of a time when the medium should next become idle. The NAV is reset each time a valid frame is received that is not addressed to the wireless communication device. The NAV effectively serves as a time duration that must elapse before the wireless communication device may contend for access even in the absence of a detected symbol or a detected energy below the relevant threshold.

As described above, the DCF is implemented through the use of time intervals. These time intervals include the slot time (or “slot interval”) and the Inter-Frame Space (IFS). The slot time is the basic unit of timing and may be determined based on one or more of a transmit-receive turnaround time, a channel sensing time, a propagation delay and a MAC processing time. Measurements for channel sensing are performed for each slot. All transmissions may begin at slot boundaries. Different varieties of IFS exist including the short IFS (SIFS), the distributed IFS (DIFS), the extended IFS (EIFS), and the arbitration IFS (AIFS). For example, the DIFS may be defined as the sum of the SIFS and two times the slot time. The values for the slot time and IFS may be provided by a suitable standard specification, such as the IEEE 802.11 family of standards (such as that defined by the IEEE 802.11-2016 specification or amendments thereof).

When the NAV reaches 0, the wireless communication device performs the physical carrier sensing. If the channel remains idle for the appropriate IFS (for example, the DIFS), the wireless communication device initiates a backoff timer, which represents a duration of time that the device must sense the medium to be idle before it is permitted to transmit. The backoff timer is decremented by one slot each time the medium is sensed to be idle during a corresponding slot interval. If the channel remains idle until the backoff timer expires, the wireless communication device becomes the holder of a Transmit Opportunity (TXOP) and may begin transmitting. The TXOP is the duration of time the wireless communication device can transmit frames over the channel after it has won contention for the wireless medium. If, on the other hand, one or more of the carrier sense mechanisms indicate that the channel is busy, a MAC controller within the wireless communication device will not permit transmission.

Each time the wireless communication devices generates a new PPDU for transmission in a new Transmit Opportunity (TXOP), it randomly selects a new backoff timer duration. The available distribution of the numbers that may be randomly selected for the backoff timer is referred to as the Contention Window (CW). If, when the backoff timer expires, the wireless communication device transmits the PPDU but the medium is still busy, there may be a collision. Additionally, if there is otherwise too much energy on the wireless channel resulting in a poor signal-to-noise ratio (SNR), the communication may be corrupted or otherwise not successfully received. In such instances, the wireless communication device may not receive a communication acknowledging the transmitted PDU within a timeout interval. The MAC may then increase the CW exponentially, for example, doubling it, and randomly select a new backoff timer duration from the CW before each attempted retransmission of the PPDU. Before each attempted retransmission, the wireless communication device may wait for the appropriate IFS (for example, DIFS) and, if the medium remains idle, then proceed to initiate the new backoff timer. There are different CW and TXOP durations for each of the four Access Categories (ACs): voice (AC_VO), video (AC_VI), background (AC_BK), and best effort (AC_BE). This enables particular types of traffic to be prioritized in the network.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels.

Each PPDU is a composite structure that includes a PHY preamble and a physical layer convergence protocol (PLCP) service data unit (PSDU). The information provided in the preamble may be used by a receiving device to decode the subsequent data in the PSDU. A legacy portion of the preamble may include a legacy short training field (STF) (L-STF), a legacy long training field (LTF) (L-LTF), and a legacy signaling field (L-SIG). The legacy preamble may be used for packet detection, automatic gain control and channel estimation, among other uses. The legacy preamble also may be used to maintain compatibility with legacy devices. In instances in which PPDUs are transmitted over a bonded channel, the L-STF, L-LTF, and L-SIG fields may be duplicated and transmitted in each of the multiple component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

APs 102 and STAs 104 can support multi-user (MU) transmissions; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user orthogonal frequency division multiple access (MU-OFDMA) and multi-user multiple-input, multiple-output (MU-MIMO) techniques.

In MU-OFDMA schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. RUs may be allocated in 2 MHz intervals, and as such, the smallest RU includes 26 tones consisting of 24 data tones and 2 pilot tones. As such, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Therefore, it may be possible to schedule as many as 74 STAs 104 for MU-OFDMA transmissions. Larger 52 tone, 106 tone, 242 tone, 484 tone and 996 tone RUs may also be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID one or more RUs that can be used to send UL traffic to the AP 102. The AP also may designate one or more random access (RA) RUs that unscheduled STAs 104 may contend for.

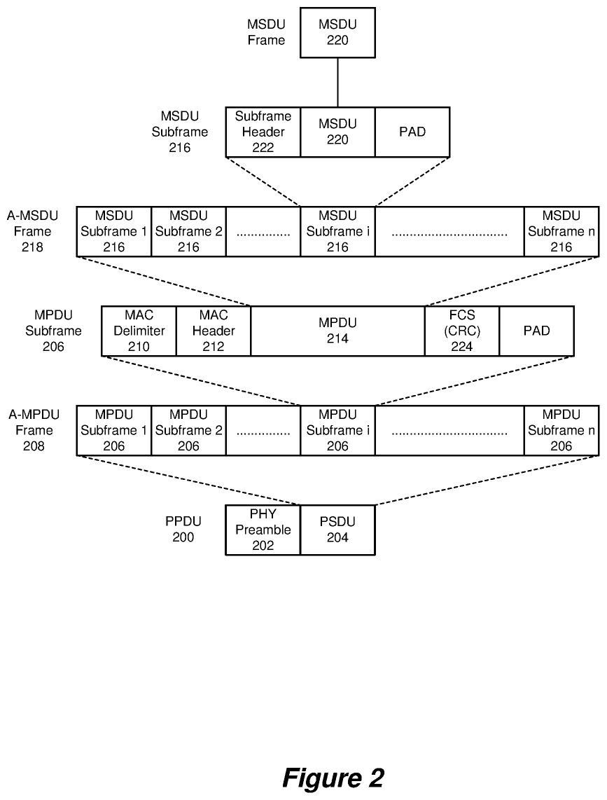

FIG. 2 shows an example PPDU 200 usable for communications between an AP 102 and a number of STAs 104. As described above, each PPDU 200 includes a PHY preamble 202 and a PSDU 204. Each PSDU 204 may carry one or more MAC protocol data units (MPDUs) 206. For example, each PSDU 204 may carry an aggregated MPDU (A-MPDU) 208 that includes an aggregation of multiple MPDU subframes 206. Each MPDU subframe 206 may include a MAC delimiter 210 and a MAC header 212 prior to the accompanying MPDU 214, which comprises the data portion (“payload” or “frame body”) of the MPDU subframe 206. The MPDU 214 may carry one or more MAC service data unit (MSDU) subframes 216. For example, the MPDU 214 may carry an aggregated MSDU (A-MSDU) 218 including multiple MSDU subframes 216. Each MSDU subframe 216 contains a corresponding MSDU 220 preceded by a subframe header 222.

Referring back to the MPDU subframe 206, the MAC header 212 may include a number of fields containing information that defines or indicates characteristics or attributes of data encapsulated within the frame body 214. The MAC header 212 also includes a number of fields indicating addresses for the data encapsulated within the frame body 214. For example, the MAC header 212 may include a combination of a source address, a transmitter address, a receiver address or a destination address. The MAC header 212 may include a frame control field containing control information. The frame control field specifies the frame type, for example, a data frame, a control frame, or a management frame. The MAC header 212 may further including a duration field indicating a duration extending from the end of the PPDU until the end of an acknowledgment (ACK) of the last PPDU to be transmitted by the wireless communication device (for example, a block ACK (BA) in the case of an A-MPDU). The use of the duration field serves to reserve the wireless medium for the indicated duration, thus establishing the NAV. Each MPDU subframe 206 may also include a frame check sequence (FCS) field 224 for error detection. For example, the FCS field 216 may include a cyclic redundancy check (CRC).

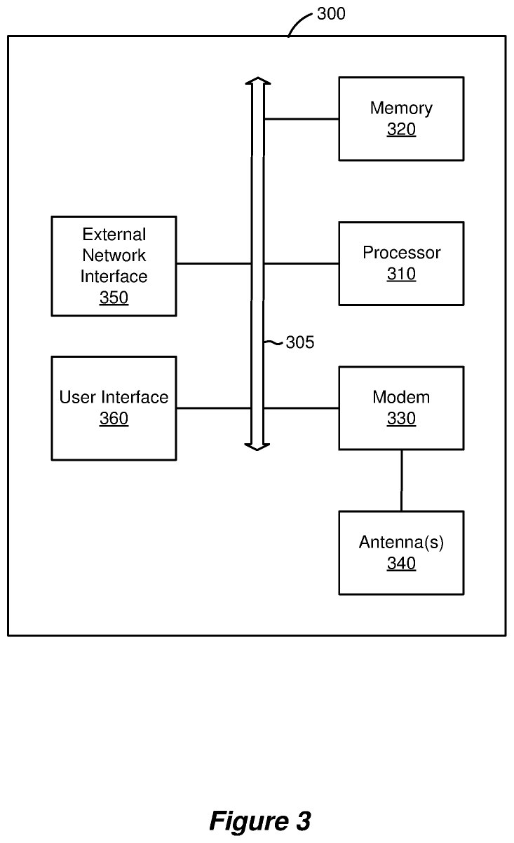

FIG. 3 shows a block diagram of an example access point (AP) 300 for use in wireless communication. For example, the AP 300 may be an example of aspects of the AP 102 described with reference to FIG. 1. The AP 300 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 300 includes at least one processor 310 (collectively “the processor 310”), at least one memory 320 (collectively “the memory 320”), at least one modem 330 (collectively “the modem 330”), at least one antenna 340 (collectively “the antenna 340”), at least one external network interface 350 (collectively “the network interface 350”) and, in some instances, a user interface (UI) 360. Each of the components (or “modules”) described with reference to FIG. 3 can communicate with other ones of the components, directly or indirectly, over at least one bus 305.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the modem 330 and the external network interface 330. The processor 310 also can process information to be sent to the modem 330 for transmission through the antenna 340 and information to be sent to the external network interface 330. The processor 310 can generally be configured to perform various operations related to generating and transmitting a downlink frame and receiving an uplink frame.

The memory 320 can include random access memory (RAM) and read-only memory (ROM). The memory 320 also can store processor- or computer-executable software (SW) code containing instructions that, when executed by the processor 310, cause the processor to perform various functions described herein for wireless communication, including generation and transmission of a downlink frame and reception of an uplink frame.

The modem 330 is generally configured to modulate packets and to provide the modulated packets to the antenna 340 for transmission, as well as to demodulate packets received from the antenna 340 to provide demodulated packets. The modem 330 generally includes or is coupled with at least one radio frequency (RF) transmitter and at least one RF receiver, which may be combined into one or more transceivers, and which are in turn coupled to one or more antennas 340. For example, in some AP implementations, the AP 300 can include multiple transmit antennas (each with a corresponding transmit chain) and multiple receive antennas (each with a corresponding receive chain). The modem 330 can communicate bi-directionally, via the antenna 340, with at least one STA (such as the STA 104 described with reference to FIG. 1).

The modem 330 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

The AP 300 may communicate with a core or backhaul network through the external network interface 350 to gain access to external networks including the Internet. For example, the external network interface 350 may include one or both of a wired (for example, Ethernet) network interface or wireless (for example, LTE, 4G or 5G) network interface.

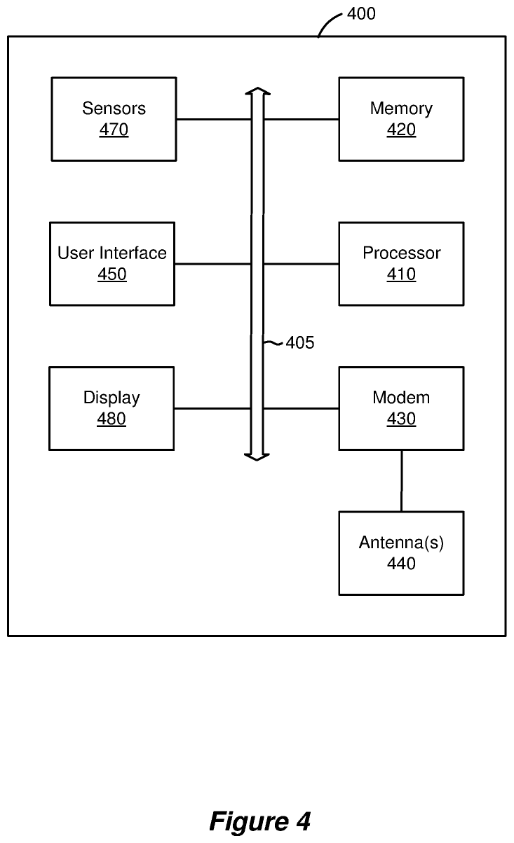

FIG. 4 shows a block diagram of an example wireless station (STA) 400 for use in wireless communication. For example, the STA 400 may be an example of aspects of the STA 104 described with reference to FIG. 1. The STA 400 is capable of transmitting and receiving wireless communications, as well as of encoding and decoding such communications. The wireless communications may conform to any of a number of different wireless communication protocols. For example, the STA 400 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 400 may be capable of transmitting and receiving Bluetooth packets conforming to a Bluetooth standard, such as defined in IEEE 802.15 or by the Bluetooth SIG. Additionally or alternatively, the STA 400 may be capable of transmitting and receiving wireless packets associated with the Long Term Evolution (LTE), International Mobile Telecommunications-Advanced (IMT-Advanced) 4G or 5G standards.

The STA 400 includes at least one processor 410 (collectively “the processor 410”), at least one memory 420 (collectively “the memory 420”), at least one modem 430 (collectively “the modem 430”) and at least one antenna 440 (collectively “the antenna 440”). In some implementations, the STA 400 additionally includes some or all of the following: a user interface (UI) 450 (such as a touchscreen or keypad), one or more sensors 470 (such as one or more inertial sensors, accelerometers, temperature sensors, pressure sensors, or altitude sensors), and a display 480. Each of the components (or “modules”) described with reference to Figure I can communicate with one another, directly or indirectly, over at least one bus 405.

The processor 410 includes an intelligent hardware device such as, for example, a CPU, a microcontroller, an ASIC or a PLD such as an FPGA, among other possibilities. The processor 410 processes information received through the modem 430 as well as information to be sent to the modem 430 for transmission through the antenna 440. The processor 410 can be configured to perform various operations related to receiving a downlink frame and generating and transmitting an uplink frame.

The memory 420 can include RAM and ROM. The memory 420 also can store processor- or computer-executable SW code containing instructions that, when executed, cause the processor 410 to perform various functions described herein for wireless communication, including reception of a downlink frame and generation and transmission of an uplink frame.

The modem 430 is generally configured to modulate packets and provide the modulated packets to the antenna 440 for transmission, as well as to demodulate packets received from the antenna 440 to provide demodulated packets. The modem 430 generally includes or is coupled with at least one radio frequency (RF) transmitter and at least one RF receiver, which may be combined into one or more transceivers, and which are in turn coupled to one or more antennas 440. For example, in some implementations, the STA 400 can include multiple transmit antennas (each with a corresponding transmit chain) and multiple receive antennas (each with a corresponding receive chain). The modem 430 can communicate bi-directionally, via the antenna 440, with at least one AP (such as the AP 102 or AP 400 described with reference to FIGS. 1 and 4, respectively). As is described above, in some implementations, the modem also can communicate bi-directionally, via the antenna 440, with other STAs directly without the use of an intermediary AP.

The modem 430 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 410 for processing, evaluation or interpretation, for example, by one or more host applications executing on the processor.

As described above, access to the shared wireless medium is governed by a DCF, which is implemented through the use of CSMA/CA and timing intervals. Before transmitting data, the wireless communication device must perform a CCA and determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine whether the channel is busy. Physical carrier sensing also includes energy detection, which involves measuring the total energy the wireless communication device receives over the channel regardless of whether the received signal represents a valid frame. If the total energy detected is above a threshold, the medium is considered busy. Virtual carrier sensing is accomplished via the use of a NAV, an indicator of a time when the medium should next become idle. The NAV is reset each time a valid frame is received that is not addressed to the wireless communication device. The NAV effectively serves as a time duration that must elapse before the wireless communication device may contend for access even in the absence of a detected symbol or a detected energy below the relevant threshold.

When the NAV reaches 0, the wireless communication device performs the physical carrier sensing. If the channel remains idle for the appropriate IFS (for example, the DIFS), the wireless communication device initiates a backoff timer, which represents a duration of time that the device must sense the medium to be idle before it is permitted to transmit. Each time the wireless communication devices generates a new PPDU for transmission, it may randomly select a new backoff timer duration. If the channel remains idle until the backoff timer expires, the wireless communication device becomes the holder of a TXOP and may begin transmitting. If, when the backoff timer expires, the wireless communication device transmits the PPDU but the medium is still busy, there may be a collision. Additionally, if there is otherwise too much energy on the wireless channel resulting in a poor SNR, the communication may be corrupted or otherwise not successfully received. In such instances, the wireless communication device may not receive an ACK acknowledging the transmitted PDU within an ACK timeout duration. The MAC may then increase the CW exponentially, for example, doubling it, and randomly select a new backoff timer duration from the CW before each attempted retransmission of the PPDU.

To better address the actual characteristics of the shared wireless communication medium, it is desirable to differentiate collisions from instances of poor SNR. For example, to more efficiently access the wireless communication medium, the MAC controller of the wireless communication device should perform one or more different actions depending on whether the lack of receipt of an ACK is due to a collision or due to poor SNR. For example, it may be desirable for the MAC controller to respond to a collision by performing a backoff operation, for example, by selecting a new backoff timer duration and waiting for the wireless channel to be idle for an appropriate duration (for example, DIFS) before initiating the new backoff timer and attempting retransmission. In response to poor SNR, it may be desirable for the rate adaptation algorithm of the MAC controller to reduce the modulation and coding scheme (MCS) to lower the data rate and thereby increase the probability of successful reception of the PPDU by the intended recipient. In some such implementations, after determining to reduce the MCS, the MAC controller may then perform a backoff operation before attempting retransmission at the reduced MCS.

Techniques for differentiating between collisions and instances of poor SNR may be based on a count of Block ACK (BA) failures on a per-user (per-station) basis. For example, if a wireless communication device (such as an AP) detects that a threshold number (for example, three) of consecutive BAs have failed on a per-STA basis, the device may determine that a current BA failure is the result of poor SNR or otherwise not the result of a collision. Conversely, if a wireless communication device detects that the number of consecutive BA failures is less than the threshold number, the device may determine that a current BA failure is the result of a collision.

BA failures in many typical WLAN environments are the result of collisions of the associated PPDUs with transmissions from other STAs or APs in the same or other BSSs, as opposed to collisions of the BAs themselves. For example, the long packet lengths or transmission durations associated with DL MU-OFDMA or DL MU-MIMO transmissions make it more likely that the associated PPDUs will collide with other users' transmissions. Techniques for differentiating between collisions and instances of poor SNR present challenges in various wireless network environments, but especially dense wireless network environments utilizing wireless communication protocols supporting DL MU-OFDMA and DL MU-MIMO transmissions (such as IEEE 802.11ax and EHT) while also allowing legacy UL SU transmissions. For example, in a dense WLAN, the large number of STAs required to transmit UL Transmission Control Protocol (TCP) acknowledgements (TCP ACKS) may result in a high collision rate. Each UL TCP ACK is a data packet from the MAC perspective. Some of these UL TCP ACKs may collide with subsequent DL MU-OFDMA or DL MU-MIMO transmissions.

TCP is a transport-layer reliable-stream-delivery service which guarantees that all bytes received will be uncorrupted and in the correct order. TCP keeps track of what are referred to as segments, the individual units of data transmission that a message is divided into for efficient routing through the network. For example, when a file is sent from a web server, the TCP software layer of that server divides it into segments and forwards them individually to the network layer, for example, an internet protocol (IP) layer, which then encapsulates each TCP segment into an IP packet by adding a header that includes, among other data, the destination IP address. The network layer then forwards the IP packets to the MAC, which generates and forwards MPDUs (for example, as A-MPDUs) to the PHY, when encapsulates them into PPDUs. When a client program executing on the recipient STA receives the data, the TCP layer reassembles the individual segments and ensures they are error free and correctly ordered as it streams them to an application. Reliability is guaranteed through a technique referred to as positive acknowledgement with re-transmission, which requires the recipient to respond with a TCP ACK as it receives the segments. The transmitter maintains a record of each segment it transmits and initiates a respective timer when the segment is transmitted. The transmitting device retransmits a segment if the timer expires before receiving the acknowledgement.

As described above, in a dense WLAN, the number of STAs vying for access to the shared wireless medium may result in a high collision rate, and thus, there will be more BA failures. To reduce the number of collisions, an AP may schedule and trigger UL MU-OFDMA or UL MU-MIMO transmissions from multiple STAs, but the collision rate may still be relatively high. Because there will be more BA failures, it is more likely that the number of consecutive BA failures will increase, and as such, more likely that an AP will interpret a current BA failure as resulting from poor SNR or otherwise not the result of a collision. Consequently, the AP may lower the MCS and data rate assuming that poor SNR is to blame for BA failures. However, because the BA failures may be predominantly the result of collisions, lowering the MCS may not reduce the BA failure rate. As such, the AP may continue to lower the MCS to no avail, and ultimately, significantly reduce throughput.

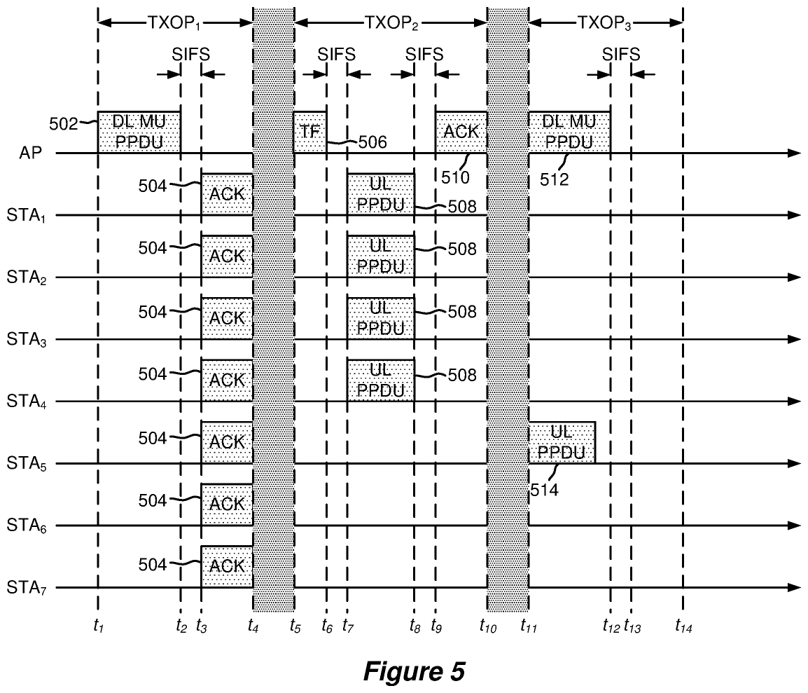

FIG. 5 shows a timing diagram illustrating an example sequence of wireless communications. The wireless communication devices transmitting the communications may be executing within an AP and multiple stations STA₁-STA₇. In the illustrated example, the AP has identified the group of stations STA₁-STA₇ as having UL data buffered for transmission to the AP. At time t₁, the AP wins the contention for the channel, becomes the owner of a first transmit opportunity TXOP₁, and transmits a first DL MU PPDU 502 to the stations STA₁-STA₇. For example, the first DL MU PPDU 502 can include a respective A-MPDU for each of the stations STA₁-STA₇. At time t₂ the first DL MU PPDU 502 ends and one SIFS later, at time t₃, each of the stations STA₁-STA₈ participates in an UL MU transmission to transmit a respective ACK 504, for example, a BA, acknowledging the respective A-MPDU. At time t₄, TXOP₁ ends.

The AP identifies a second group of stations STA₁-STA₄ having UL data buffered for transmission to the AP and allocates resources to the second group of stations STA₁-STA₄ for an upcoming UL MU transmission. In the illustrated example, the second group of stations STA₁-STA₄ include a subset of the first group of stations STA₁-STA₇. After at least one DIFS and zero or more intervening TXOPs, the AP again wins the channel at time t₅, becomes the owner of a second transmit opportunity TXOP₂ and transmits a second DL MU PPDU 506 to the second group of stations STA₁-STA₄. In the illustrated example, the second DL MU PPDU 506 includes a trigger frame (TF). At time t6 the TF 506 ends and one SIFS later, at time t₇, each of the stations STA₁-STA₄ participates in an UL MU transmission to transmit respective UL PPDUs 508. At time t₈ the UL MU transmission ends and one SIFS later, at time t₉, the AP transmits a multi-STA ACK 510, for example, a multi-STA BA, acknowledging the respective UL PPDUs 508. At time t₁₀, TXOP₂ ends.

The AP identifies a third group of stations STA₁, STA₃ and STA₄ having UL data buffered for transmission to the AP and allocates resources to the third group of stations for an upcoming UL MU transmission. After at least one DIFS and zero or more intervening TXOPs, the AP again wins the channel at time t₁₁, becomes the owner of a third transmit opportunity TXOP₃ and transmits a third DL MU PPDU 512 to the second group of stations STA₁, STA₃ and STA₄. However, STA₅ transmits an UL SU PPDU 514 concurrently with the transmission of the third DL MU PPDU 512 transmitted by the AP. The UL SU PPDU 514 collides with the DL MU PPDU 512. As such, the third group of stations STA₁, STA₃ and STA₄ fails to successfully receive the DL MU PPDU 512 and as a consequence, do not transmit any ACKs (for example, BAs) at time t₁₃. At time t₁₄, TXOP₃ ends.

As described above, if the AP detects that the number of consecutive BA failures, including the current ACK failure, for one or more of the third group of stations STA₁, STA₃ and STA₄, is less than a threshold number, the AP may determine, correctly, that the current BA failure for the respective station is the result of a collision. Conversely, if the AP determines that the number of consecutive BA failures for one or more of the third group of stations STA₁, STA₃ and STA₄ is greater than the threshold number, the AP may determine, incorrectly, that the current BA failure for the respective station is the result of poor SNR or otherwise not the result of a collision. The AP may then improperly lower the MCS associated with the respective stations STA₁, STA₃ and STA₄.

Because network conditions may vary, the threshold value used in differentiating collisions from poor SNR should also change dynamically. For example, as the number of STAs contending for access increases, the threshold value should also increase. Because the expected number of collisions is relatively high in dense network environments supporting MU transmissions, the threshold value should also be relatively high making it more likely that a given BA failure will be interpreted as a collision, and not resulting from poor SNR.

Various implementations relate generally to techniques for collision detection. Particular implementations more specifically relate to techniques for dynamically changing a threshold value used for distinguishing a collision from other network conditions such as poor SNR. For example, a wireless communication device, in response to not receiving an ACK, may compare the number of consecutive ACK failures to the threshold value. If the number of consecutive ACK failures is greater than the threshold value, the wireless communication device may determine that the current ACK failure is the result of poor SNR or other adverse network characteristics. Conversely, if the number of consecutive ACK failures is less than the threshold value, the wireless communication device may determine that the current ACK failure is the result of a collision. The wireless communication device may perform different actions depending on whether the current ACK failure is the result of a collision or poor SNR. For example, the wireless communication device may initiate a backoff operation in response to determining that the current ACK failure is the result of a collision, and may initiate a reduction in MCS in response to determining that the current ACK failure is the result of poor SNR.

In some implementations, a wireless communication device within an AP calculates, selects or otherwise determines the threshold value based on an expected number of STAs that will contend for access to transmit respective SU PPDUs. Additionally or alternatively, the wireless communication device may determine the threshold value based on a number of targeted recipients of a first MU transmission and a number of selected transmitters scheduled for a second MU transmission. For example, the AP may identify a first group of STAs to participate in a first DL MU transmission to concurrently receive data from the AP. The AP may identify a second group of STAs to participate in a second UL MU transmission to concurrently transmit data to the AP. In some such implementations, the AP may determine the threshold value based at least in part on a ratio of the number of STAs in the first group to the number of STAs in the second group. For example, the AP may increase the threshold value proportionately to the ratio. In other words, as the number of UL scheduled users increases, the AP would reduce the threshold. Conversely, as the number of non-scheduled users increases, and thus the expected number of users that will contend for access to the wireless medium increases, the AP would increase the threshold.

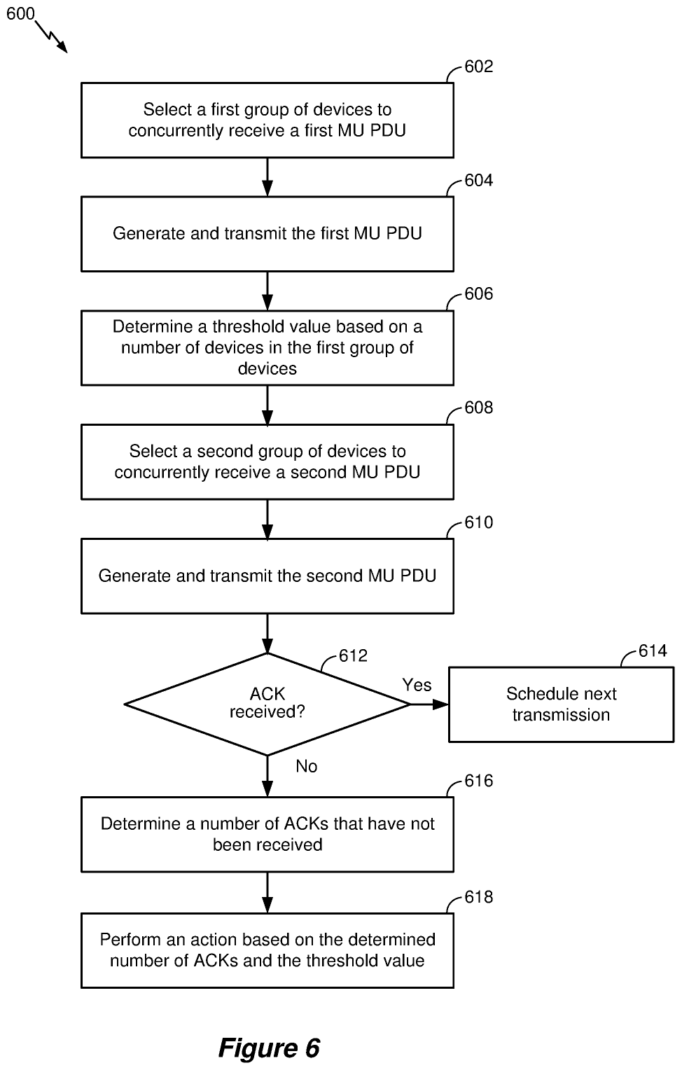

FIG. 6 shows a flowchart illustrating an example process 600 for detecting collisions according to some implementations. In some implementations, the process 600 may be performed by a first wireless communication device such as one of the APs 102 or 300 described above with reference to FIGS. 1 and 3, respectively. The process 600 also may be performed by a software-enabled AP (SoftAP) such as, for example, one of the STAs 104 or 400 described above with reference to FIGS. 1 and 4, respectively. In some implementations, the process 600 begins in block 602 with selecting a first group of wireless communication devices (such as STAs 104 or 400) to concurrently receive a first MU PDU that includes a respective first PDU for each of the first group of wireless communication devices. In some such implementations, the first MU PDU is a DL MU OFDMA PPDU or a DL MU MU-MIMO PPDU (such as the first DL MU PPDU 502 described with reference to FIG. 5). In block 604, the process 600 proceeds with generating and transmitting the first MU PDU to the first group.

The first wireless communication device determines a threshold value in block 606 for identifying collisions of PDUs based on a number of wireless communication devices in the first group. In some implementations, the threshold value determined in block 606 is subsequently used in detecting collisions for each and every device in the first group. In some implementations, the same threshold value is also applied to other devices not in the first group. In some other implementations, threshold values can be tailored on a per-station basis. Additionally, in some implementations, block 606 is performed on a per-TXOP basis such that a new threshold value may be generated for each subsequent TXOP.

In block 608, the process 600 continues with selecting a second group of wireless communication devices to concurrently receive a second MU PDU that includes a respective second PDU for each of the second group of wireless communication devices. In some such implementations, the second MU PDU is a DL MU OFDMA PPDU or a DL MU MU-MIMO PPDU (such as the DL MU PPDU 512 described with reference to FIG. 5). In block 610, the process 600 proceeds with generating and transmitting the second MU PDU to the second group. In some implementations or instances, the transmission of the first MU PDU occurs during a first TXOP and the transmission of the second MU PDU occurs during a TXOP subsequent to the first TXOP.

The first wireless communication device then, in block 612, determines on a per-user basis whether an ACK (for example, a BA) acknowledging the second MU PDU has been received from each wireless communication device of the second group within a threshold duration of time referred to as an ACK timeout duration (for example, one SIFS plus one slot duration). If the first wireless communication device determines, in block 612, that all expected ACKs have been received, the device then proceeds to schedule a subsequent transmission in block 614. If, however, the first wireless communication device determines in block 612 that an ACK has not been received from one or more of the second group of wireless communication devices, then it proceeds in block 616 to determine a number of ACKs that have not been received. In some implementations, the first wireless communication device more specifically identifies the number of consecutive BA failures on a per-station basis in block 616. For example, the first wireless communication device may be configured to track BA failures on a per-station basis across TXOPs and to increase an associated missed BA counter by one for each consecutive missed BA (the first wireless communication device may be configured to reset the missed BA counter to zero responsive to receiving a BA from the respective device).

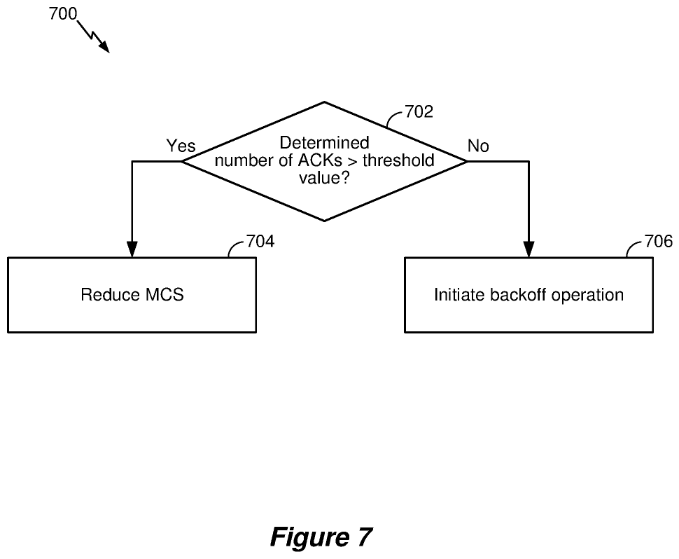

In block 618, the first wireless communication device then performs one or more actions based on the determined number of consecutive BA failures and the threshold value determined in block 606. FIG. 7 shows a flowchart illustrating an example process 700 for performing one or more actions based on a determined number of ACK failures and a threshold value according to some implementations. For example, the process 700 may be an example implementation of block 618 of the process 600 described with reference to FIG. 6. The process 700 begins in block 702 with determining whether the number of consecutive ACK (for example, BA) failures is greater than or equal to the threshold value. As described above, the first wireless communication device should perform one or more different actions depending on whether the lack of receipt of BA is due to a collision or due to poor SNR. In some implementations, if the first wireless communication device determines in block 702 that the number of consecutive BA failures is greater than the threshold value, it then interprets the BA failure as resulting from poor SNR or other adverse network conditions, and consequently reduces, in block 704, the MCS associated with the respective station from whom the BA was not received. If the first wireless communication device determines in block 702 that the number of consecutive BA failures is less than the threshold value, it then interprets the BA failure as a collision and initiates a backoff operation in block 706. For example, the first wireless communication device may, in block 706, increase a contention window, randomly select a new backoff timer duration from the contention window and wait for the wireless channel to be idle for an appropriate duration (for example, DIFS) before initiating the new backoff timer and attempting retransmission. As described above, after determining to reduce the MCS, the MAC controller may then also perform a backoff operation before attempting retransmission at the reduced MCS.

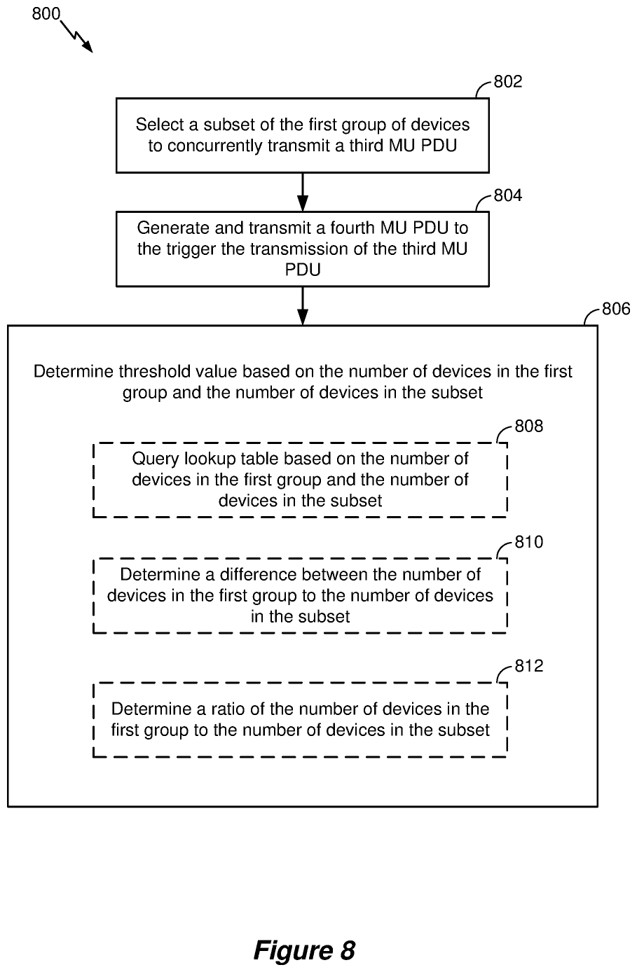

FIG. 8 shows a flowchart illustrating an example process 800 for determining a threshold value for identifying collisions according to some implementations. For example, the process 800 may be an example implementation of block 606 of the process 600 described with reference to FIG. 6. In addition to selecting a first group of wireless communication devices to participate in receiving a first DL MU PPDU as in block 602, the process 800 additionally includes selecting, in block 802, a subset of the first group to participate in transmitting a third MU PDU that includes a respective third PDU for the first wireless communication device from each of the second group of wireless communication devices. In some such implementations, the third MU PDU is an UL MU OFDMA PPDU or an UL MU MU-MIMO PPDU that includes an UL PPDU from each of the second group (such as the UL PPDUs 508 described with reference to FIG. 5). In block 804, the process 800 proceeds with generating and transmitting a fourth PDU (which may be an MU PPDU or a SU PPDU) to the subset of the first group. The fourth PDU is or includes a trigger frame (such as the trigger frame 506 described with reference to FIG. 5) to trigger the subset of the first group to begin the transmission of the third MU PDU. The transmission of the third MU PDU may occur during the first TXOP or a subsequent TXOP.

The process 800 proceeds in block 806 with determining a threshold value for identifying collisions of PDUs based on the number of wireless communication devices in the first group and the number of wireless communication devices in the subset. For example, block 806 may be an example implementation of block 606 of the process 600 described with reference to FIG. 6. In some implementations, determining the threshold value in block 806 includes querying a lookup table in block 808. The lookup table may be stored within the first wireless communication device and include a threshold value for each combination of the number of devices in the first group and the number of devices in the subset. For example, the lookup table may include a threshold value of 4 (for didactic purposes only) when the number of devices in the first group is 7 and the number of devices in the second group is 4.

Additionally or alternatively, in some implementations, determining the threshold value in block 806 includes determining, in block 810, a difference between the number of wireless communication devices in the first group and the number of wireless communication devices in the subset. Additionally or alternatively, in some implementations, determining the threshold value in block 806 includes determining, in block 812, a ratio of the number of wireless communication devices in the first group to the number of wireless communication devices in the subset. In some such implementations, the first wireless communication device may determine the threshold value be querying a lookup table that includes a threshold value for each of multiple possible ratios. In some implementations, the threshold value is proportional to the ratio. In some such implementations, the higher the ratio, the higher the threshold value. In other words, as the number of wireless communication devices in the subset (the number of UL scheduled users) decreases, the ratio increases, and so does the threshold value. Conversely, as the number of UL scheduled users increases, the ratio decreases and so does the threshold value because the expected number of users that will contend for access to the wireless medium decreases.

In implementations or instances in which the first DL MU PPDU includes segments of TCP frames for the first group of wireless communication devices, the UL PPDUs transmitted by the subset of the first group may include TCP ACKs. However, the other devices of the first group that were not scheduled to participate in the third MU PDU still need to transmit their respective TCP ACKs. In such instances, as the number of devices in the subset increases, the expected number of collisions should decrease because fewer unscheduled devices will be contending for access to transmit their respective TCP ACKs, and as such, the threshold value should decrease. In this way, as the collision rate is estimated to decrease, a reduced threshold value will make it more likely that a given BA failure will be treated as resulting from poor SNR or otherwise not the result of a collision. Conversely, as the number of devices in the subset decreases, the expected number of collisions should increase because more unscheduled devices will be contending for access to transmit their respective TCP ACKs, and as such, the threshold value should increase. In this way, as the collision rate is estimated to increase, an increased threshold value will make it more likely that a given BA failure will be treated as resulting from a collision. However, it should be repeated that the threshold value may be proportional to the ratio. If the threshold value is too large, the first wireless communication device may interpret too many BA failures as resulting from collisions, and as such, would initiate backoff operations too often resulting in a decrease of the time utilization of the wireless medium and, as a consequence, a reduction in throughput. On the other hand, if the threshold value is too small, the first wireless communication device may interpret too many BA failures as resulting from poor SNR, and as such, unnecessarily reduce the MCS resulting in a reduction in throughput.

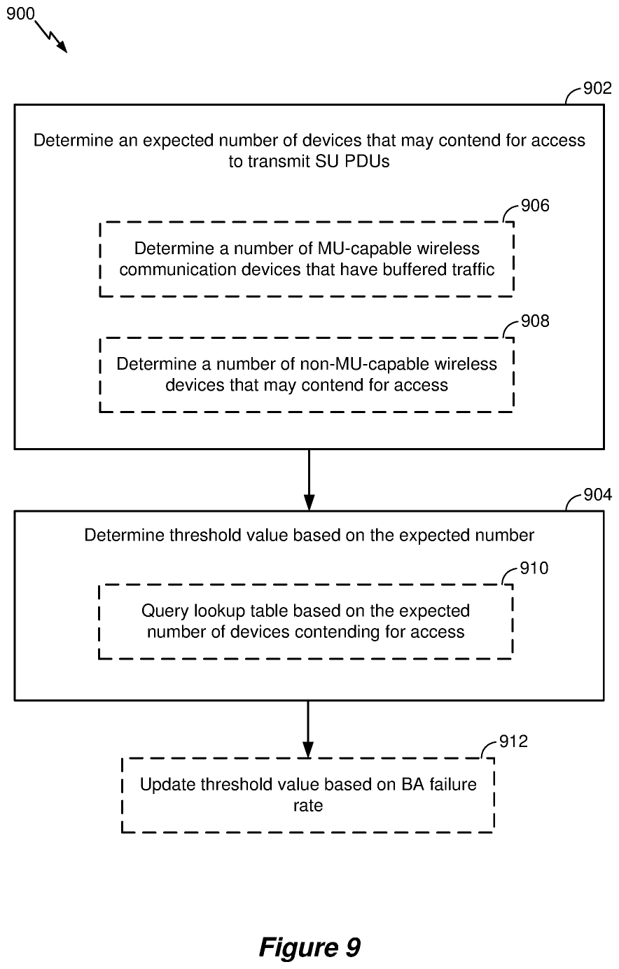

FIG. 9 shows a flowchart illustrating an example process 900 for determining a threshold value for identifying collisions according to some implementations. For example, the process 900 may be an example implementation of block 606 of the process 600 described with reference to FIG. 6. The process 900 begins in block 902 with determining an expected number of wireless communication devices that may contend for access to transmit respective single-user (SU) PDUs to the first wireless communication device based on the number of wireless communication devices in the first group of wireless communication devices. In block 904, the process proceeds with determining the threshold value for identifying collisions of PDUs based on the expected number.

The determination of the expected number in block 902 may include determining a number of wireless communication devices outside of the first group that may contend for access to transmit respective SU PDUs to the first wireless communication device. In some implementations, the determination of the number of wireless communication devices outside of the first group includes determining, in block 906, a number of MU-capable wireless communication devices that have buffered traffic for the first wireless communication device. For example, the first wireless communication device may poll MU-capable devices for buffer status reports. The first wireless communication device may then identify the number of MU-capable wireless devices that have buffered traffic for the first wireless communication device based on the received buffer status reports. In some implementations, the determination of the number of wireless communication devices outside of the first group additionally or alternatively includes determining, in block 908, a number of non-MU-capable wireless communication devices that that may contend for access to transmit respective SU PDUs to the first wireless communication device. For example, the first wireless communication device may identify non-MU-capable wireless communication devices that have transmitted SU PDUs to the first wireless communication device within a threshold duration of time. The first wireless communication device may then determine the number of non-MU-capable wireless communication devices that may contend for access based on the identified number.

The first wireless communication device may then add the number of MU-capable devices that have buffered traffic and the estimated number of non-MU-capable devices that have buffered traffic to obtain the expected number of wireless communication devices outside of the first group that may contend for access to transmit respective SU PDUs to the first wireless communication device for a subsequent TXOP. The first wireless communication device may then add the expected number of wireless communication devices outside of the first group that may contend for access to transmit respective SU PDUs to the first wireless communication device to the number of wireless communication devices of the first group that are not scheduled for a subsequent trigger-based MU transmission to the first wireless communication device to obtain the total expected number of devices that may contend for access for the subsequent TXOP.

In some implementations, determining the threshold value based on the expected number in block 904 includes querying a lookup table that includes a threshold value for each of multiple possible expected numbers or possible expected number ranges (“buckets”) in block 910. In some implementations, the threshold value is proportional to the expected number. In some such implementations, the higher the expected number, the higher the threshold value. In other words, as the number of wireless communication devices expected to contend for access increases, so does the threshold value.

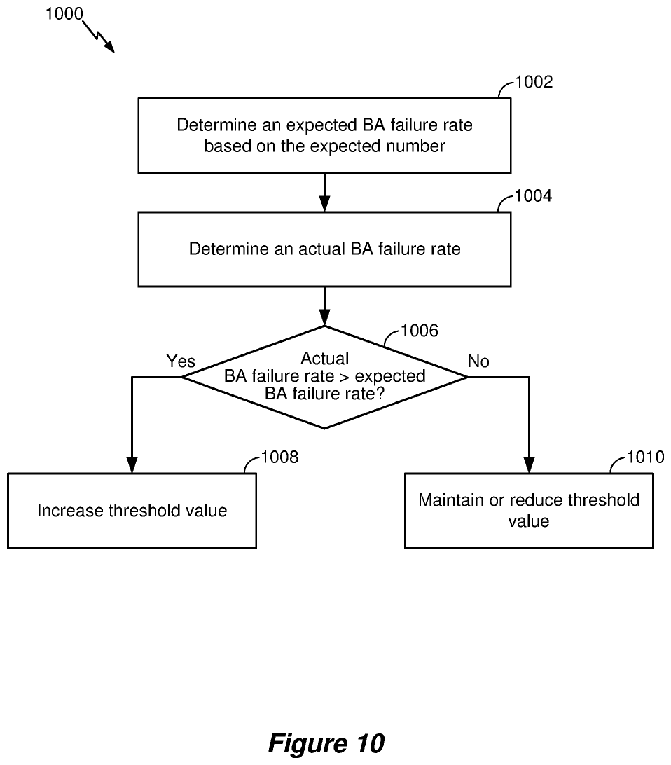

In some implementations, the process 900 optionally includes updating, in block 912, the threshold value determined in block 904 based on a subsequent BA failure rate. FIG. 10 shows a flowchart illustrating an example process 1000 for updating a threshold value according to some implementations. For example, the process 1000 may be an implementation of block 912 of the process 900. In some implementations, the process 1000 begins in block 1002 with determining an expected BA failure rate based on the expected number. For example, the expected BA failure rate may be based on an expected collision rate given the expected number of wireless communication devices contending for access. The expected BA failure rates for the variety of expected numbers of wireless communication devices contending for access can be obtained from a stored lookup table. In some implementations, determining the expected BA failure rate based on the expected number in block 1002 includes querying a lookup table that includes an expected BA failure rate for each of multiple possible expected numbers or possible expected number ranges (buckets). The expected BA failure rates are proportional to the expected number of devices contending for access. Such a lookup table may be populated empirically, for example, using a simulator to offline train on measured collision rates versus the number of contending devices.

In block 1004, the first wireless communication device determines an actual BA failure rate. The process 1000 proceeds in block 1006 with determining whether the actual BA failure rate is greater than the expected BA failure rate. In some implementations, if the actual BA failure rate is greater than the expected BA failure rate, the first wireless communication device may increase the threshold value in block 1008. For example, if the actual BA failure rate is greater than or equal to the expected BA failure rate after reducing the MCS associated with a recipient device, it may be determined that the additional BA failures are due to collisions, and as such, the first wireless communication device may increase the threshold value. Conversely, if the actual BA failure rate is less than the expected BA failure rate after reducing the MCS, the first wireless communication device may maintain or reduce the threshold value in block 1010.

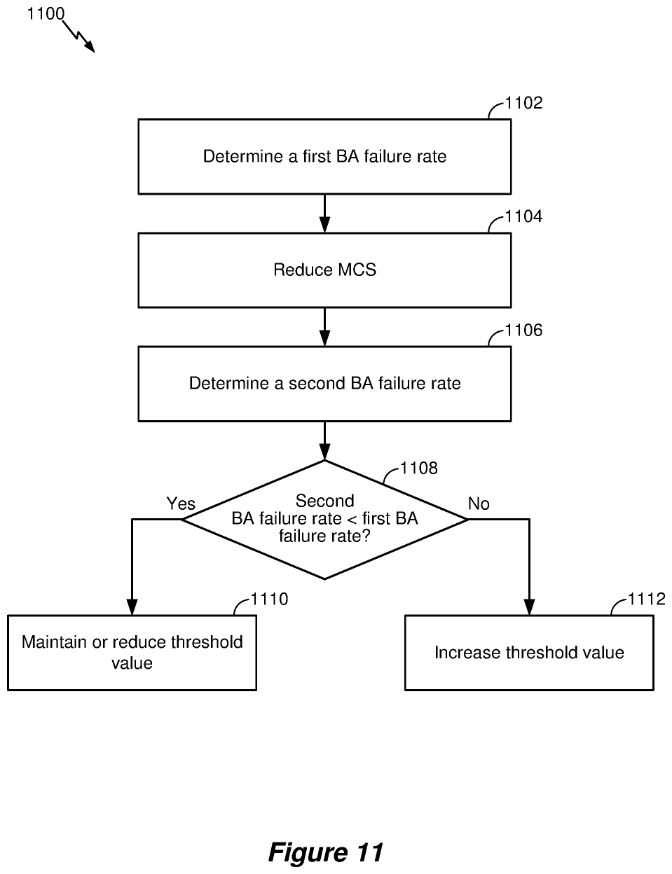

FIG. 11 shows a flowchart illustrating another example process 1100 for updating a threshold value according to some implementations. The process 1102 begins in block 1102 with determining a current (first) BA failure rate. In block 1104, the first wireless communication device reduces the MCS associated with a recipient device. Block 1104 may be an implementation of block 704 of the process 700. After reducing the MCS, in a subsequent TXOP, the first wireless communication device proceeds to again determine a current (second) BA failure rate in block 1106. The process proceeds in block 1108 with determining whether the second BA failure rate is less than the first BA failure rate. In some implementations, if the first wireless communication device determines in block 1108 that the second BA failure rate is less than the first BA failure rate, it maintains or reduces the threshold value in block 1110. Conversely, if the first wireless communication device determines in block 1108 that the second BA failure rate is greater than or equal to the first BA failure rate, it increases the threshold value in block 1112.

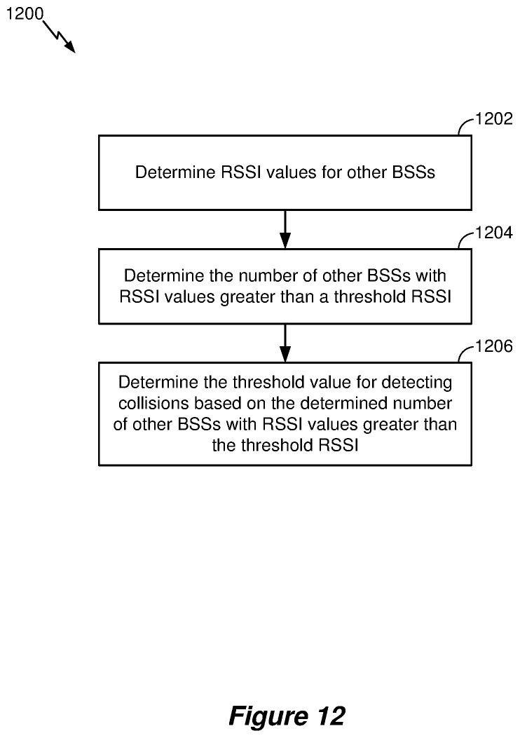

Referring back to any of blocks 606, 806 and 904, in some implementations, the first wireless communication device can determine the threshold value based on one or more additional factors. FIG. 12 shows a flowchart illustrating an example process 1200 for determining a threshold value based on other BSS (OBSS) characteristics according to some implementations. The process 1200 may be performed independently of the processes 600, 800 or 900 or may be performed as part of any of the processes 600, 800 or 900, for example, as part of blocks 606, 806 and 904, respectively. In block 1202, the process 1200 begins with determining RSSI values for the other BSSs. For example, the first wireless communication device may measure RSSI values associated with transmissions from neighboring APs or may request neighbor reports from its associated STAs that include RSSI values for other BSSs in proximity to the respective STAs. The process 1200 proceeds in block 1204 with comparing the RSSI values to a threshold RSSI value and determining the number of other BSSs (or the number of neighboring APs) with RSSI values above the threshold RSSI. In block 1206, the process proceeds with determining the threshold value based on the determined number of other BSSs with RSSI values above the threshold RSSI.

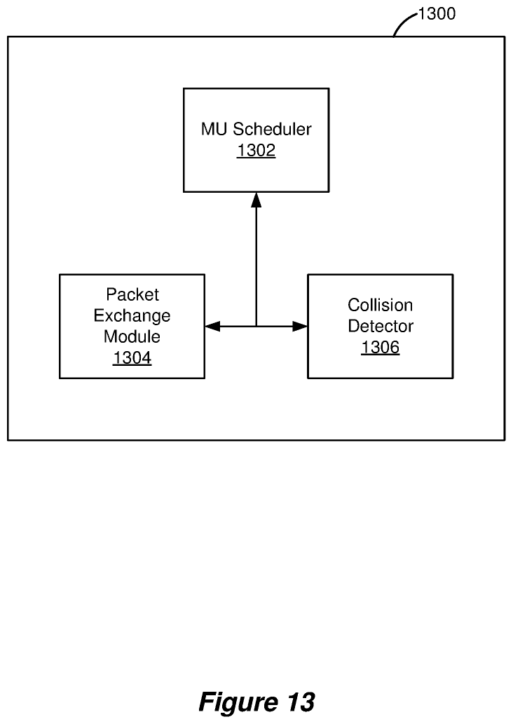

FIG. 13 shows a block diagram of an example wireless communication device 1300 for use in wireless communication according to some implementations. In some implementations, the wireless communication device 1300 can be an example of a device for use in an AP such as one of the APs 102 and 300 described above with reference to FIGS. 1 and 3, respectively. In some other implementations, the wireless communication device 1300 can be for use as a SoftAP such as by one of the STAs 104 and 400 described above with reference to FIGS. 1 and 4, respectively. In some implementations, the wireless communication device 1300 is configured to perform one or more of the processes 600, 700, 800, 900, 1000, 1100 and 1200 described above with reference to FIGS. 6-12, respectively. The wireless communication device 1300 includes an MU scheduler 1302, a packet exchange module 1304 and a collision detector 1306. Portions of one or more of the modules 1302, 1304, 1306, 1308, 1310 and 1312 may be implemented at least in part in hardware or firmware. For example, the packet exchange module 1304 may be implemented at least in part by one or more modems (for example, a Wi-Fi (IEEE 802.11) modem such as modem 430). In some implementations, at least some of the modules 1302, 1304 and 1306 are implemented at least in part as software stored in a memory (such as the memory 420). For example, portions of one or more of the modules 1302, 1304 and 1306 can be implemented as non-transitory instructions (or “code”) executable by at least one processor (such as the processor 410) to perform the functions or operations of the respective module.

The MU scheduler 1302 is configured to select wireless communication devices (such as STAs 104 or 400) to concurrently receive MU PDUs that include respective PDUs for each of the selected wireless communication devices. In some such implementations, the MU PDUs are DL MU OFDMA PPDUs or DL MU MU-MIMO PPDUs. For example, the MU scheduler 1302 can be configured to perform blocks 602 and 608 of the process 600 described with reference to FIG. 6 to select the first and the second groups of wireless communication devices to concurrently receive DL MU PDUs, such as the first DL MU PPDU 502 and the second DL MU PPDU 512 described with reference to FIG. 5. The MU scheduler 1302 also may perform block 802 of the process 800 described with reference to FIG. 8 to select a group of wireless communication devices to concurrently transmit an MU transmission, such as the UL MU PDU including the UL PPDUs 508 described with reference to FIG. 5. The MU scheduler 1302 is further configured to schedule resources (for example, time, frequency and spatial resources) for the DL and UL MU transmissions and to coordinate with the packet exchange module 1304 to cause the packet exchange module 1304 to generate and transmit PDUs based on the determined schedules of resources.

The packet exchange module 1304 is configured to generate, transmit and receive PDUs including MU PDUs and SU PDUs based on the schedule of resources received from the MU scheduler 1302. For example, the packet exchange module 1304 can include a PHY layer and a MAC layer to generate MPDUs and encapsulate them into PPDUs, and to receive PPDUs and extract the MPDUs within. For example, the packet exchange module 1304 can be configured to perform blocks 604 and 610 of the process 600 described with reference to FIG. 6 to generate and transmit the first and second MU PDUs to the first and the second groups of wireless communication devices. The packet exchange module 1304 also can be configured to perform block 804 of the process 800 described with reference to FIG. 8 to generate and transmit a trigger frame, such as the trigger frame 506 described with reference to FIG. 5, to trigger the transmission of an UL MU PDU. The packet exchange module 1304 can further be configured to receive ACKs, such as BAs, from respective wireless communication devices acknowledging the receipt of respective PPDUs.

The packet exchange module 1304 may receive instructions from the collision detector 1306 and perform one or more actions based on the instructions. For example, the packet exchange module 1304 can be configured to perform block 618 of the process 600 described with reference to FIG. 6. In some implementations, the packet exchange module 1304 is specifically configured to perform the process 700 described with reference to FIG. 7. As described above, the wireless communication device 1300 should perform one or more different actions depending on whether the lack of receipt of an ACK is due to a collision or due to poor SNR. In some implementations, the packet exchange module 1304 is configured to reduce the MCS associated with a respective station from whom an ACK was not received at the instruction of the collision detector. In some implementations, the packet exchange module 1304 is configured to initiate a backoff operation at the instruction of the collision detector.

The collision detector 1306 is configured to monitor for ACKs received by the packet exchange module 1304 from wireless communication devices that are recipients of DL PPDUs transmitted from the packet exchange module 1304. The collision detector 1306 is configured to determine, on a per-user basis, whether an expected ACK was received from the respect wireless communication device within an ACK timeout duration. For example, the collision detector 1306 can be configured to perform block 612 of the process 600 described with reference to FIG. 6. If the collision detector 1306 determines that an ACK has not been received from one or more of the recipients of a MU transmission, it then proceeds to determine, for each of the one or more recipients, a number of ACKs that have not been received (for example, a number of consecutive ACK failures). For example, the collision detector 1306 can be configured to perform block 616 of the process 600 described with reference to FIG. 6. In some implementations, the collision detector 1306 may be configured to track BA failures on a per-station basis across TXOPs and to increase an associated missed BA counter by one for each consecutive missed BA (the collision detector 1306 may be configured to reset the missed BA counter to zero responsive to receiving a BA from the respective device).

The collision detector 1306 is further configured to compare the number of consecutive ACK failures to a threshold value and to cause the performance of one or more actions based on the comparison of the number of consecutive ACK failures to the threshold value. For example, the collision detector 1306 can be configured to perform, or cause the performance of, block 618 of the process 600 described with reference to FIG. 6. As described above, the wireless communication device 1300 should perform one or more different actions depending on whether the lack of receipt of an ACK is due to a collision or due to poor SNR. In some implementations, if the collision detector 1306 determines that the number of consecutive ACK failures is greater than the threshold value, it then interprets the ACK failure as resulting from poor SNR or otherwise not the result of a collision, and then sends an instruction to the packet exchange module 1304 to cause the packet exchange module 1304 to reduce the MCS associated with the respective station from whom the ACK was not received. In contrast, if the collision detector 1306 determines that the number of consecutive ACK failures is less than the threshold value, it then interprets the ACK failure as a collision and sends an instruction to the packet exchange module 1304 to cause the packet exchange module 1304 to initiate a backoff operation.

The collision detector 1306 may be configured to determine the threshold value by any suitable means tailored to achieve any desirable effects based on any applicable network environment conditions. In some implementations, the collision detector 1306 is configured to select the threshold value on a dynamic basis, for example, on a per-TXOP basis. In some implementations, the threshold value is subsequently used in detecting collisions for each and every user. In some other implementations, threshold values can be tailored on a per-station basis. In some implementations, the collision detector 1306 is configured to select the threshold value based on a number of stations the MU scheduler 1302 has scheduled to receive a DL MU PPDU in a current TXOP. For example, the collision detector 1306 can be configured to perform block 606 of the process 600 described with reference to FIG. 6 to determine the threshold value. In some implementations, the collision detector 1306 can be specifically configured to perform block 806 of the process 800 described with reference to FIG. 8 to determine the threshold value based on the number of devices scheduled for a DL transmission and the number of devices scheduled for a subsequent UL transmission. Additionally or alternatively, in some implementations, the collision detector 1306 can be specifically configured to perform blocks 902 and 904 of the process 900 described with reference to FIG. 9 to determine an expected number of devices that may contend for access to transmit SU PDUs for a subsequent TXOP, and to determine the threshold value based on the expected number. The collision detector 1306 can further be configured to increase, maintain or reduce the threshold value. For example, the collision detector 1306 can be configured to perform block 912 of the process 900 described with reference to FIG. 9, or one or both of the processes 1000 and 1100 described with reference to FIGS. 10 and 11, respectively.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication performed by a first wireless communication device, comprising:
selecting a first plurality of wireless communication devices to concurrently receive a first multi-user (MU) protocol data unit (PDU) that includes a respective first PDU for each of the first plurality of wireless communication devices;
outputting for transmission the first MU PDU;
determining a threshold value for identifying collisions of PDUs based on a number of wireless communication devices in the first plurality of wireless communication devices;
selecting a second plurality of wireless communication devices to concurrently receive a second MU PDU that includes a respective second PDU for each of the second plurality of wireless communication devices;
outputting for transmission the second MU PDU;
determining that an acknowledgment (ACK) acknowledging the respective second PDU has not been received from a second wireless communication device of the second plurality of wireless communication devices within a threshold duration of time;
determining a number of ACKs, including the ACK, that have not been received from the second wireless communication device; and
performing an action based on the determined number of ACKs and the threshold value.

2. The method of claim 1, wherein:
the transmission of the first MU PDU occurs during a first transmit opportunity (TXOP) of the first wireless communication device;
the transmission of the second MU PDU occurs during a second TXOP of the first wireless communication device subsequent to the first TXOP; and
the method further comprises updating the threshold value on a per-TXOP basis based on the number of wireless communication devices selected to concurrently receive an MU PDU from the first wireless communication device during the respective TXOP.

3. The method of claim 1, further comprising:
selecting at least a subset of the first plurality of wireless communication devices to concurrently transmit a third MU PDU to the first wireless communication device; and
outputting for transmission a fourth PDU after transmitting the second MU PDU to trigger the transmission of the third MU PDU from the subset of the first plurality of wireless communication devices.

4. The method of claim 3, wherein the determination of the threshold value for identifying collisions of PDUs based on the number of wireless communication devices in the first plurality of wireless communication devices comprises determining the threshold value based on the number of wireless communication devices in the first plurality of wireless communication devices and the number of wireless communication devices in the subset of the first plurality of wireless communication devices.

5. The method of claim 4, wherein the determination of the threshold value comprises querying a lookup table to obtain the threshold value based on the number of wireless communication devices in the first plurality of wireless communication devices and the number of wireless communication devices in the subset of the first plurality of wireless communication devices.

6. The method of claim 5, wherein the determination of the threshold value comprises determining the threshold value based on a ratio of the number of wireless communication devices in the first plurality of wireless communication devices to the number of wireless communication devices in the subset of the first plurality of wireless communication devices.

7. The method of claim 1, further comprising determining an expected number of wireless communication devices that may contend for access to transmit respective single-user (SU) PDUs to the first wireless communication device based on the number of wireless communication devices in the first plurality of wireless communication devices, wherein the determination of the threshold value for identifying collisions of PDUs based on the number of wireless communication devices in the first plurality of wireless communication devices comprises determining the threshold value based on the expected number.

8. The method of claim 7, wherein:
the determination of the expected number further comprises determining a number of wireless communication devices outside of the first plurality of wireless communication devices that may contend for access to transmit respective SU PDUs to the first wireless communication device;
the determination of the number of wireless communication devices outside of the first plurality of wireless communication devices comprises determining a number of MU-capable wireless communication devices that have buffered traffic for the first wireless communication device; and
the determination of the number of MU-capable wireless devices that have buffered traffic for the first wireless communication device comprises:
receiving a buffer status report from each of a plurality of MU-capable wireless devices; and
identifying the number of MU-capable wireless devices that have buffered traffic for the first wireless communication device based on the received buffer status reports.

9. The method of claim 8, wherein:
the determination of the number of wireless communication devices outside of the first plurality of wireless communication devices comprises determining a number of non-MU-capable wireless communication devices that may contend for access to transmit respective SU PDUs to the first wireless communication device; and
the determination of the number of non-MU-capable wireless communication devices that may contend for access comprises:
identifying non-MU-capable wireless communication devices that have transmitted SU PDUs to the first wireless communication device within a threshold duration of time; and
determining the number of non-MU-capable wireless communication devices that may contend for access based on the identified non-MU-capable wireless communication devices.

10. The method of 7, further comprising:
determining an expected ACK failure rate based on the expected number;
determining an actual ACK failure rate;
increasing the threshold value responsive to determining that the actual ACK failure rate is greater than the expected ACK failure rate; and
maintaining or reducing the threshold value responsive to determining that the actual ACK failure rate is less than the expected ACK failure rate.

11. The method of claim 1, wherein the determination of the threshold value further comprises:
determining a received signal strength indicator (RSSI) value associated with each of one or more neighboring APs;
comparing the RSSI values with a threshold RSSI; and
determining the number of neighboring APs having associated RSSI values greater than the RSSI threshold, wherein the determination of the threshold value is further based on the determined number of neighboring APs having associated RSSI values greater than the RSSI threshold.

12. The method of claim 1, wherein:
the determination of the number of ACKs that have not been received includes determining the number of consecutive ACKs, including the ACK, that have not been received from the second wireless communication device;
the performance of the action is based on the determined number of consecutive ACKs.

13. The method of claim 1, wherein the performance of the action based on the determined number of ACKs and the threshold value comprises initiating a backoff operation responsive to determining that the number of ACKs is less than the threshold value.

14. The method of claim 1, wherein the performance of the action based on the determined number of ACKs and the threshold value comprises reducing a modulation and coding scheme (MCS) associated with transmissions of PDUs to the second wireless communication device responsive to determining that the number of ACKs is greater than the threshold value.

15. The method of claim 14, further comprising:
determining a first ACK failure rate prior to reducing the MCS;
determining a second ACK failure rate after reducing the MCS;
increasing the threshold value responsive to determining that the second ACK failure rate is greater than or equal to the first ACK failure rate; and
maintaining or reducing the threshold value responsive to determining that the second ACK failure rate is less than the first ACK failure rate.

16. A wireless communication device comprising:
at least one processor; and
at least one memory communicatively coupled with the at least one processor and storing processor-readable code that, when executed by the at least one processor, causes the wireless communication device to perform operations including:
selecting a first plurality of wireless communication devices to concurrently receive a first multi-user (MU) protocol data unit (PDU) that includes a respective first PDU for each of the first plurality of wireless communication devices;
generating and outputting the first MU PDU for transmission;
determining a threshold value for identifying collisions of PDUs based on a number of wireless communication devices in the first plurality of wireless communication devices;
selecting a second plurality of wireless communication devices to concurrently receive a second MU PDU that includes a respective second PDU for each of the second plurality of wireless communication devices;
generating and outputting the second MU PDU for transmission;
determining that an acknowledgment (ACK) acknowledging the respective second PDU has not been received from a second wireless communication device of the second plurality of wireless communication devices within a threshold duration of time;
determining a number of ACKs, including the ACK, that have not been received from the second wireless communication device; and
performing an action based on the determined number of ACKs and the threshold value.

17. The wireless communication device of claim 16, wherein:
the transmission of the first MU PDU occurs during a first transmit opportunity (TXOP) of the first wireless communication device;
the transmission of the second MU PDU occurs during a second TXOP of the first wireless communication device subsequent to the first TXOP; and
the operations further comprise updating the threshold value on a per-TXOP basis based on the number of wireless communication devices selected to concurrently receive an MU PDU from the first wireless communication device during the respective TXOP.

18. The wireless communication device of claim 16, wherein the operations further comprise:
selecting at least a subset of the first plurality of wireless communication devices to concurrently transmit a third MU PDU to the first wireless communication device; and
outputting for transmission a fourth PDU after transmitting the second MU PDU to trigger the transmission of the third MU PDU from the subset of the first plurality of wireless communication devices.

19. The wireless communication device of claim 18, wherein the determination of the threshold value for identifying collisions of PDUs based on the number of wireless communication devices in the first plurality of wireless communication devices comprises determining the threshold value based on the number of wireless communication devices in the first plurality of wireless communication devices and the number of wireless communication devices in the subset of the first plurality of wireless communication devices.

20. The wireless communication device of claim 19, wherein the determination of the threshold value comprises querying a lookup table to obtain the threshold value based on the number of wireless communication devices in the first plurality of wireless communication devices and the number of wireless communication devices in the subset of the first plurality of wireless communication devices.

21. The wireless communication device of claim 20, wherein the determination of the threshold value comprises determining the threshold value based on a ratio of the number of wireless communication devices in the first plurality of wireless communication devices to the number of wireless communication devices in the subset of the first plurality of wireless communication devices.

22. The wireless communication device of claim 16, wherein the operations further comprise determining an expected number of wireless communication devices that may contend for access to transmit respective single-user (SU) PDUs to the first wireless communication device based on the number of wireless communication devices in the first plurality of wireless communication devices, wherein the determination of the threshold value for identifying collisions of PDUs based on the number of wireless communication devices in the first plurality of wireless communication devices comprises determining the threshold value based on the expected number.

23. The wireless communication device of claim 22, wherein:
the determination of the expected number further comprises determining a number of wireless communication devices outside of the first plurality of wireless communication devices that may contend for access to transmit respective SU PDUs to the first wireless communication device;
the determination of the number of wireless communication devices outside of the first plurality of wireless communication devices comprises determining a number of MU-capable wireless communication devices that have buffered traffic for the first wireless communication device; and
the determination of the number of MU-capable wireless devices that have buffered traffic for the first wireless communication device comprises:
receiving a buffer status report from each of a plurality of MU-capable wireless devices; and
identifying the number of MU-capable wireless devices that have buffered traffic for the first wireless communication device based on the received buffer status reports.

24. The wireless communication device of claim 23, wherein:
the determination of the number of wireless communication devices outside of the first plurality of wireless communication devices comprises determining a number of non-MU-capable wireless communication devices that may contend for access to transmit respective SU PDUs to the first wireless communication device; and
the determination of the number of non-MU-capable wireless communication devices that may contend for access comprises:
identifying non-MU-capable wireless communication devices that have transmitted SU PDUs to the first wireless communication device within a threshold duration of time; and
determining the number of non-MU-capable wireless communication devices that may contend for access based on the identified non-MU-capable wireless communication devices.

25. The wireless communication device of 22, wherein the operations further comprise:
determining an expected ACK failure rate based on the expected number;
determining an actual ACK failure rate;
increasing the threshold value responsive to determining that the actual ACK failure rate is greater than the expected ACK failure rate; and
maintaining or reducing the threshold value responsive to determining that the actual ACK failure rate is less than the expected ACK failure rate.

26. The wireless communication device of claim 16, wherein the determination of the threshold value further comprises:
determining a received signal strength indicator (RSSI) value associated with each of one or more neighboring APs;
comparing the RSSI values with a threshold RSSI; and
determining the number of neighboring APs having associated RSSI values greater than the RSSI threshold, wherein the determination of the threshold value is further based on the determined number of neighboring APs having associated RSSI values greater than the RSSI threshold.

27. The wireless communication device of claim 16, wherein:
the determination of the number of ACKs that have not been received includes determining the number of consecutive ACKs, including the ACK, that have not been received from the second wireless communication device;
the performance of the action is based on the determined number of consecutive ACKs.

28. The wireless communication device of claim 16, wherein the performance of the action based on the determined number of ACKs and the threshold value comprises initiating a backoff operation responsive to determining that the number of ACKs is less than the threshold value.

29. The wireless communication device of claim 16, wherein the performance of the action based on the determined number of ACKs and the threshold value comprises reducing a modulation and coding scheme (MCS) associated with transmissions of PDUs to the second wireless communication device responsive to determining that the number of ACKs is greater than the threshold value.

30. The wireless communication device of claim 29, wherein the operations further comprise:
determining a first ACK failure rate prior to reducing the MCS;
determining a second ACK failure rate after reducing the MCS;
increasing the threshold value responsive to determining that the second ACK failure rate is greater than or equal to the first ACK failure rate; and
maintaining or reducing the threshold value responsive to determining that the second ACK failure rate is less than the first ACK failure rate.
